(19) United States
(12) Patent Application Publication
(10) Pub. No.: US 2002/0122309 A1
(43) Pub. Date: Sep. 5, 2002

(54) Led beacon lamp

(76) Inventors: Mohamed M. Abdelhafez, Old Bridge, NJ (US); Robert L. Martin, Little Silver, NJ (US); Robert Eric Johnson, Howell, NJ (US); John T. Adinolfi, Milltown, NJ (US); Chenhua You, Manasquan, NJ (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/784,160

(22) Filed: Feb. 16, 2001

(51) Int. Cl. F21V 29/00; F21V 5/04

(52) U.S. Cl. 362/294; 362/373; 362/335

(57) ABSTRACT

A beacon lamp which may find use in and around airports, communication towers, etc. The beacon lamp includes a plurality of light emitting diodes (LEDs) its as light source. The plurality of LEDs can be mounted on an LED module which is in turn secured to a base. A transparent outer cover is provided to cover the plurality of LEDs. The LED module can include heat fins to enhance heat sinking properties. The outer cover and base can also include portions to improve free air convection to also improve heat sinking properties. The LEDs may be connected in parallel to provide redundancy in the event that certain LEDs burn out. The beacon lamp is also structured to allow the outer cover to be easily removed from the base to access the LED modules, to allow easy relamping of the beacon lamp.

### BACKGROUND OF THE INVENTION

1. Field of the Invention

The present invention is directed to a beacon lamp which, for example, may be used in and around airports, communication towers, etc.

2. Discussion of the Background

Beacon lamps are in a widespread use in and around airports and on communication towers. Such beacon lamps provide warnings and indications for approaching aircraft.

Currently known beacon lamps in and around airports and on communication towers utilize incandescent or xenon lamps and typically flash their incandescent or xenon light bulbs. However, the use of such incandescent or xenon lamps results in certain drawbacks, as recognized by the inventors of the present invention.

A first drawback is that incandescent light bulbs are relatively energy inefficient, and thus use a large amount of power. A second drawback with both incandescent and xenon beacon lamps is that such lamps typically burnout within 18 to 24 months as that is the typical lifetime of an incandescent light bulb or a xenon light bulb. That is a particular drawback in beacon lamps because beacon lamps are often placed in locations which are 20 difficult and dangerous to reach. As a result, the maintenance and replacement of background incandescent and xenon beacon lamps can be both difficult and costly. A third drawback is that xenon light bulbs require a large amplitude, short duration driving pulse. That pulsing of a xenon light bulb can cause noise or electrical interference which can be extensive and detrimental to radio and cell tower transmissions.

### SUMMARY OF THE INVENTION

Accordingly, one object of the present invention is to provide a novel beacon lamp which can overcome the drawbacks in the background art.

A further more specific object of the present invention is to provide a novel beacon lamp which has improved energy efficiency.

A further more specific object of the present invention is to provide a novel beacon lamp which has a long life, to thereby reduce maintenance costs.

A further more specific object of the present invention is to provide a novel beacon lamp which does not emit any detrimental electrical interference.

To achieve the above and other objects, the present invention sets forth a novel beacon lamp which utilizes light emitting diodes (LEDs) as the illumination source. The LEDs may be interconnected and mounted on a bracket to form an LED subassembly module. The LED subassembly module may provide heat sinking for the LEDs. Further, the novel beacon lamp of the present invention is structured to allow easy relamping of the LED components. The drive circuitry for the LED components can also include various features such as providing a regulated DC current, power factor correction, harmonic distortion correction, etc.

The use of LEDs as a light source in the novel beacon lamp of the present invention provides the benefits that LEDs are significantly more energy efficient than both incandescent and xenon lamps, and thus the novel beacon lamp of the present invention has improved energy efficiency. LEDs also have a lifetime typically four to five times greater than that of incandescent and xenon light bulbs, and thus the novel beacon lamp of the present invention will have to be relamped less frequently than the background beacon lamps, to thereby reduce maintenance costs. Further, LEDs do not require short duration, large amplitude driving pulses, and thus do not emit interference which may interfere with the radio or cell towers.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 shows the novel beacon lamp of the present invention from a top perspective view;

FIG. 2 shows a novel beacon lamp of the present invention from a bottom perspective view;

FIG. 3 shows a novel beacon lamp of the present invention in an exploded view;

FIGS. 4A-4D show a specific module and lens arrangement of the novel beacon lamp of the present invention; and

FIG. 5 shows a circuit overview of drive and light emission elements of the novel beacon lamp of the present invention;

FIG. 6 shows a schematic in control circuitry of the present invention; and

FIG. 7 shows in further detail control circuitry in the present invention.

### DESCRIPTION OF THE PREFERRED EMBODIMENTS

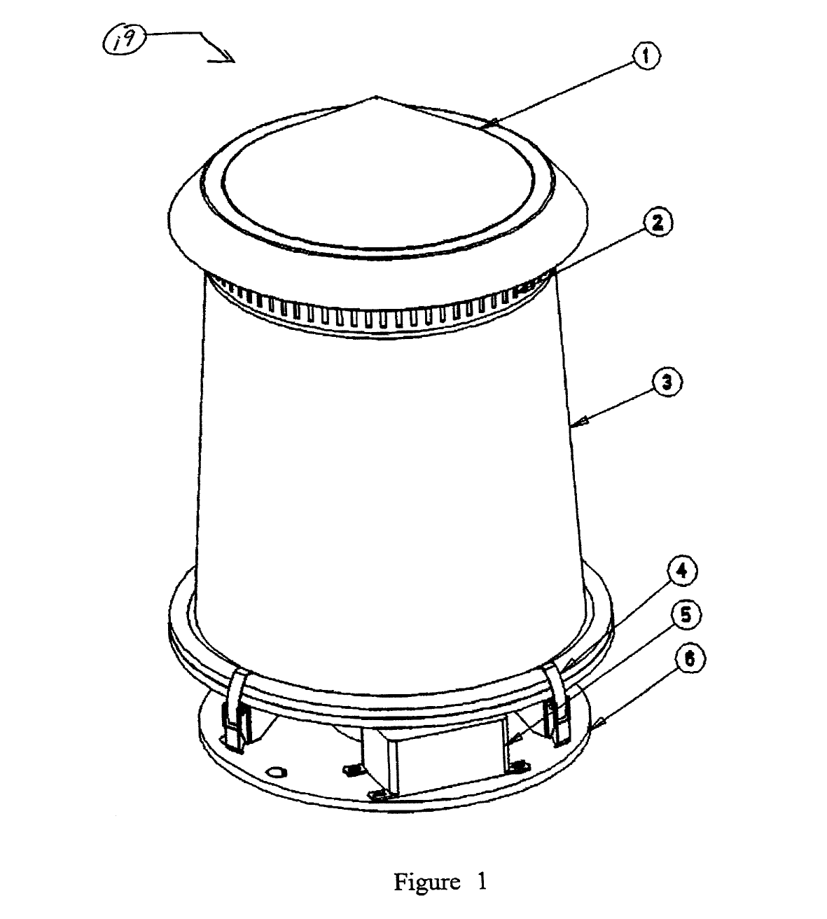

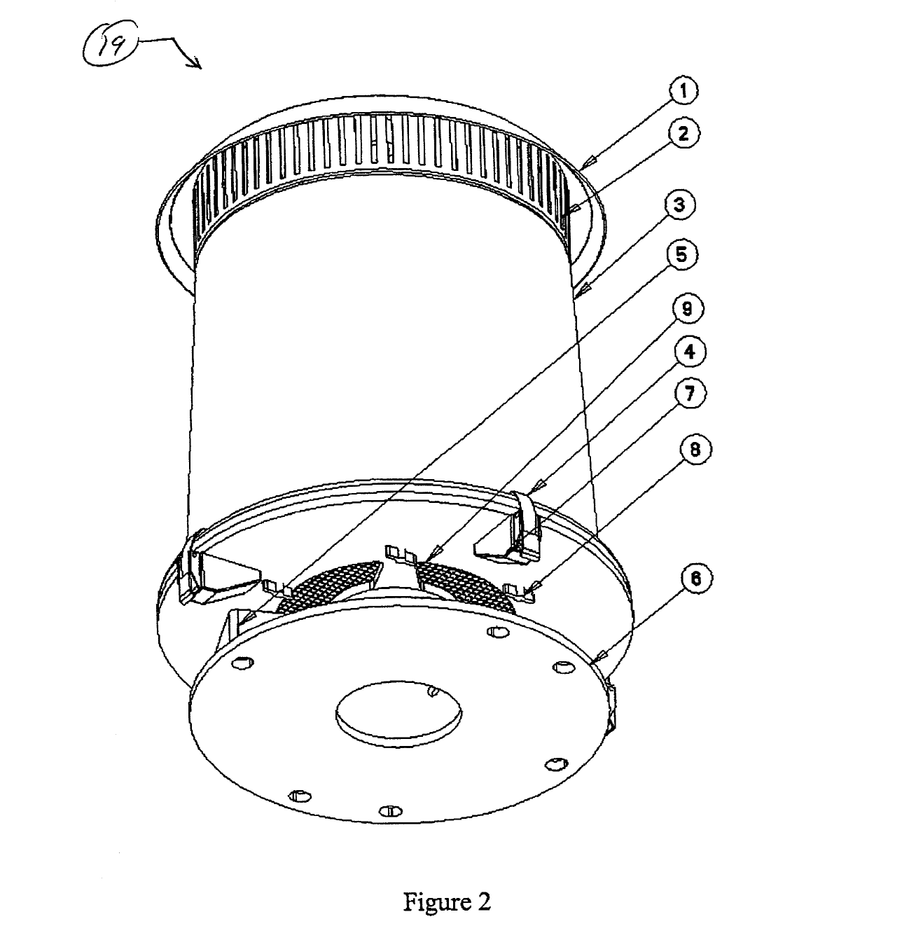

Referring now to the drawings, wherein like reference numerals designate identical or corresponding parts throughout the several views, and more particularly to FIGS. 1 and 2 thereof, the novel beacon lamp 19 of the present invention is shown.

As shown in FIGS. 1 and 2 the beacon lamp 19 of the present invention includes a base 6. The base 6 typically is a structural assembly and may be formed from a metal such as aluminum which has good heat dissipation properties, or from fiberglass or other materials. Mounted on the metal base 6 is a terminal housing 5 which provides a site for wire termination. The terminal housing 5 is a junction for wiring to connect the wiring of the beacon lamp 19 to existing wiring, such as existing tower wiring. Formed above the base 6 is an outer housing 3. The outer housing 3 is mounted onto the base 6 by a clamp latch 4. The clamp latch 4 can be clamped and unclamped to allow the outer cover 3 to be lifted off of the metal base 6. Thereby, easy access to the lamp components housed inside the outer cover 3 is provided with the structure in the present invention.

The outer cover 3 also includes a screen portion 2. The screen portion 2 is provided to allow free convection of air within the beacon lamp 19. The outer cover 3 also includes a top cover portion 1 mounted on the top of the outer cover 3. The top cover 1 may typically be formed of aluminum sheet metal, and the outer cover may typically be formed of acrylic, a clear glass, plastic material, etc., and could also be tinted to match a desired emission color. The outer cover 3 is attached to the screen portion 2, and the screen portion 2 is attached to the top cover 1.

As shown more specifically in FIG. 2, the metal base 6 also includes a screening portion 9 which is also provided to allow the free convection of air to occur within the beacon lamp 19. The screening portion 9 can also prevent infestation from bugs or birds. As also shown in FIG. 2 the clamp latch 4 is mounted to a base block 7. Module knobs 8 are also provided to secure a lamp module (shown later) to the metal base 6. The module knobs 8 also allow for the easy removal of the lamp module for relamping, as discussed further below.

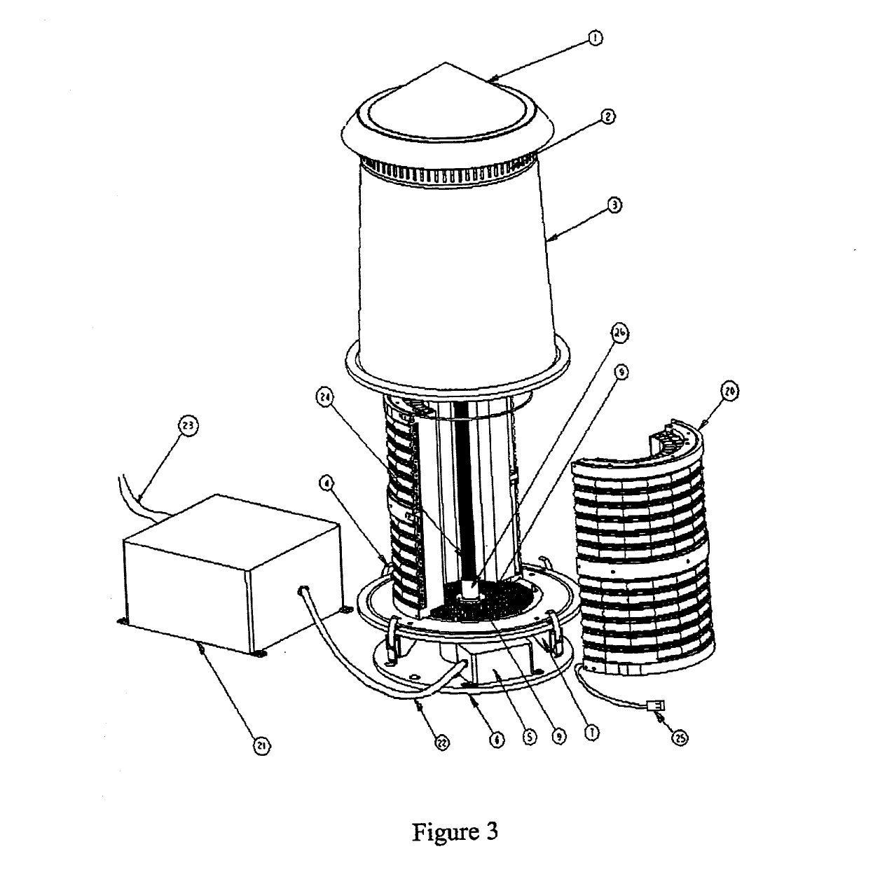

FIG. 3 shows the beacon lamp 19 of the present invention in an expanded view. As shown in FIG. 3 the outer cover 3 is mounted on a telescoping tube 24 which is securely mounted to the metal base 6 by a flange 26.

As also shown in FIG. 3, an electrical housing 21 is connected by cable 22 to the terminal housing 5. The electrical housing 21 includes at least two power-input wires 23 to connect to an existing controller (discussed further below). With such a structure in the present invention, providing power to LEDs and LED driving circuitry in the beacon lamp 19 is simply performed by connecting the beacon lamp 19 to an existing light controller, as discussed further below.

As also shown in FIG. 3 two LED modules 20 are provided on which LED elements as the illumination source for the beacon lamp 19 are provided. The LED modules 20 each include a connector 25.

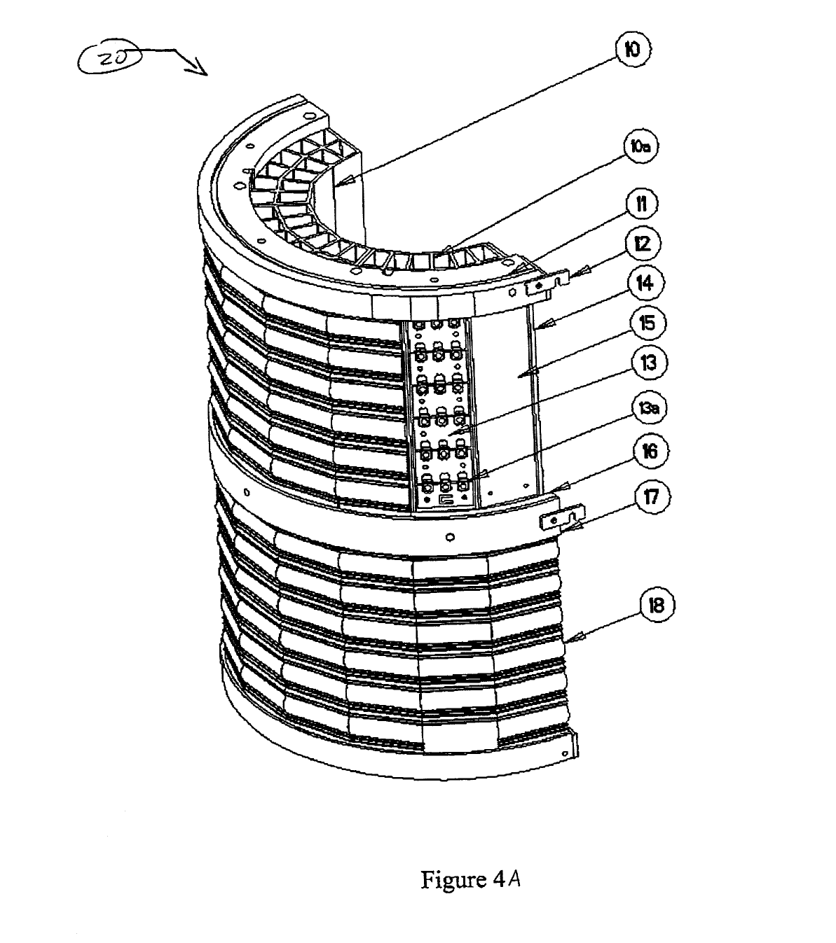

A specific structure of each LED module 20 is shown in FIG. 4A.

As shown in FIG. 4A each LED module 20 includes an LED assembly 13 mounted on an inner heat sink bracket 10. The LED assembly 13 is mounted to the inner heat sink bracket 10 via a thermally conductive electrical insulator 15, which can be formed of a material such as a pressure sensitive adhesive loaded with oxide particles and coated in Kapton thermally cool polymide film, as one example. A lens 18 is provided to mount over each LED assembly 13. The lens 18 may be formed of acrylic.

The LED assembly 13 includes a plurality of individual LED elements 13a. The LEDs 13a are specifically chosen to be high power LEDs capable of withstanding at or above 55° C. Acceptable LEDs for this purpose are SnapLED LEDS manufactured by Lumileds, such as model No. HPWS-FH00. A specific construction of the lens 18 is shown in FIGS. 4B-4D, which also specifically illustrate the shape of the lens 18. As shown in FIGS. 4B-4D, the lens 18, in the embodiment disclosed, includes six one-directionally powered plano/convex Fresnel lenses 41. Each Fresnel lens 41 is aligned with one row of LEDs of the LED assembly 13. Each Fresnel lens 41 converges light emitted from the respective row of LEDs aligned therewith in a vertical direction to keep the light unchanged in a horizontal direction, so as to better comply with applicable lighting regulations. Each Fresnel lens 41 has a convex surface as an outer surface to better rollimate the light beam and reduce light loss. The lens 18 is thus one directionally powered to converge light emitted from the LEDs. Utilizing 36 for each of two modules of such high powered LED assemblies 13 and one directionally powered converging lens 18 provides an effective luminous intensity output of minimum 1500 candela to maximum 2500 candela in an omnidirectional 360°, which meets FAA requirements set forth in circular 150/5345/43 for beacon lighting equipment.

One factor the inventors considered by utilizing LEDs as light sources is that LEDs generate heat and LEDs are sensitive to heat in the sense that light output of an LED decreases with increasing temperature. That is, the intensity of the light output by an LED typically diminishes at a rate of about 1% per ° C. Further, exposure of LEDs to increased temperatures can also reduce the lifetime of the LEDs.

In view of those problems the beacon lamp 19 of the present invention takes approaches to ensure adequate heat sinking for heat generated by the LEDs 13a. More specifically, the inner heat sink bracket 10 includes convection fins 10a and is designed to provide heat sinking for the LED assemblies 13 by providing a conductive heat path to the convection fins 10a. The convection fins 10a are designed to allow for maximized heat transfer to air and free convection.

Also, and as noted above with respect to FIGS. 1 and 2, the outer cover 3 includes the screen portion 2 and the base 6 includes the screen portion 9, which allow airflow to enhance the free convection.

It is also noted that the embodiment disclosed in FIGS. 3 and 4 of the present specification utilizes LED panels which each include six series-connected clusters of three parallel-connected LEDs. The parallel interconnection of the LEDs 13a ensures that if a single LED extinguishes only that single LED is effected. The remaining two LEDs in parallel with the extinguished LED would then share the current from the failed LED, to thereby increase the LED current and intensity in each of those two remaining LEDs by one-third, to compensate for the extinguished LED. With such a structure, three parallel LEDs 13a must fail before the entire LED panel 13 fails.

Further, in the structure shown in FIGS. 3 and 4 two LED modules 20 are provided for each beacon lamp 19. Each LED module 20 can include 18 LED panels 13. With such a structure there are 324 LEDs 13a for each LED module 20, with two parallel-connected strings of nine series-connected LED panels 13 for each module. Of course other possible embodiments could provide for LEDs 13a in series/parallel paths to provide continued, albeit partial, illumination.

Further, in the structure shown in FIG. 3 module brackets 12 are provided to secure the two LED modules 20 to each other. These brackets 12 can be replaced by clamps or other devices to fasten the two LED modules 20 to each other.

The beacon lamp 19 of the present invention is also structured to ensure easy relamping. That is, when the LEDs 13a fail or another maintenance problem arises, the system of the present invention can be easily relamped. To achieve a structure which allows for easy relamping, and as discussed above with respect to FIGS. 1 and 2, the outer cover 3 is secured to the base 6 by clamp latches 4, and the LED modules 20 are secured to the base 6 by modules knobs 8.

With such a structure, to relamp the beacon light 19 of the present invention first the outer cover 3 is unclamped from the base 6 by releasing the clamp latches 4. The outer cover 3 is then lifted from the base 6 by the operation of the telescoping tube 24. The telescoping tube 24 can then lock in an extended position to enable access to the LED modules 20. The LED modules 20 can be removed by disconnecting the connectors 25, loosening the module knobs 8, loosening the module brackets 12, and then lifting the LED modules 20 from the base 6. Then, the LED modules 20 can be replaced by new modules.

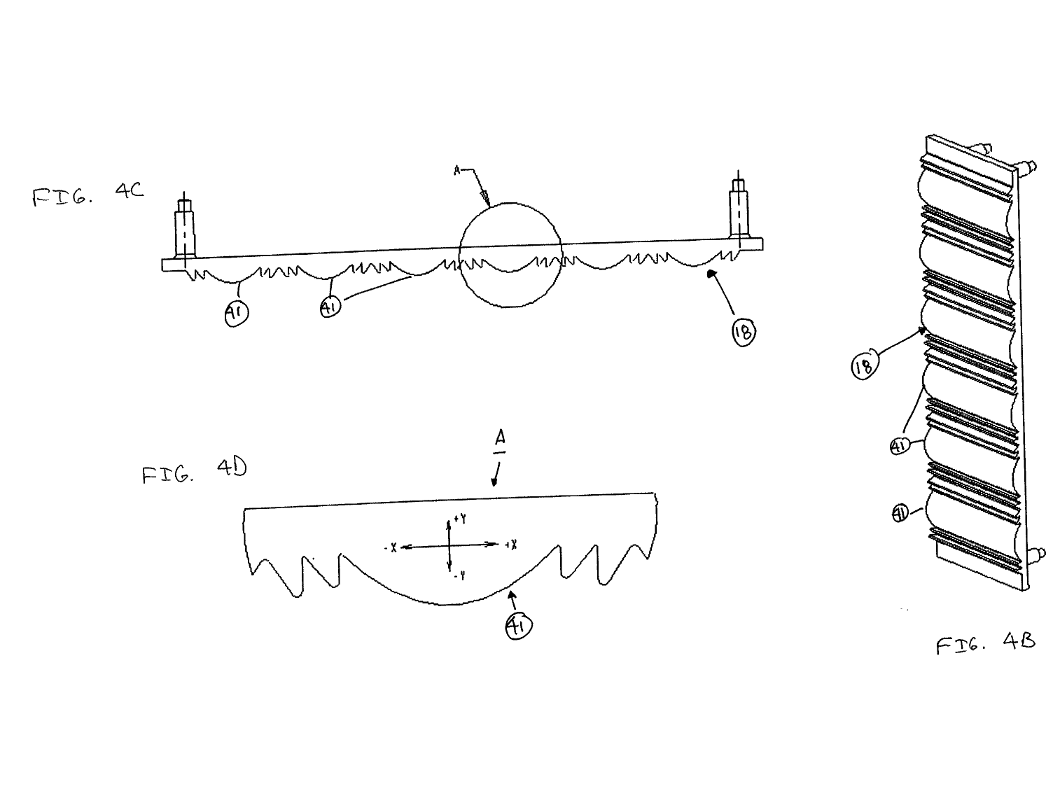

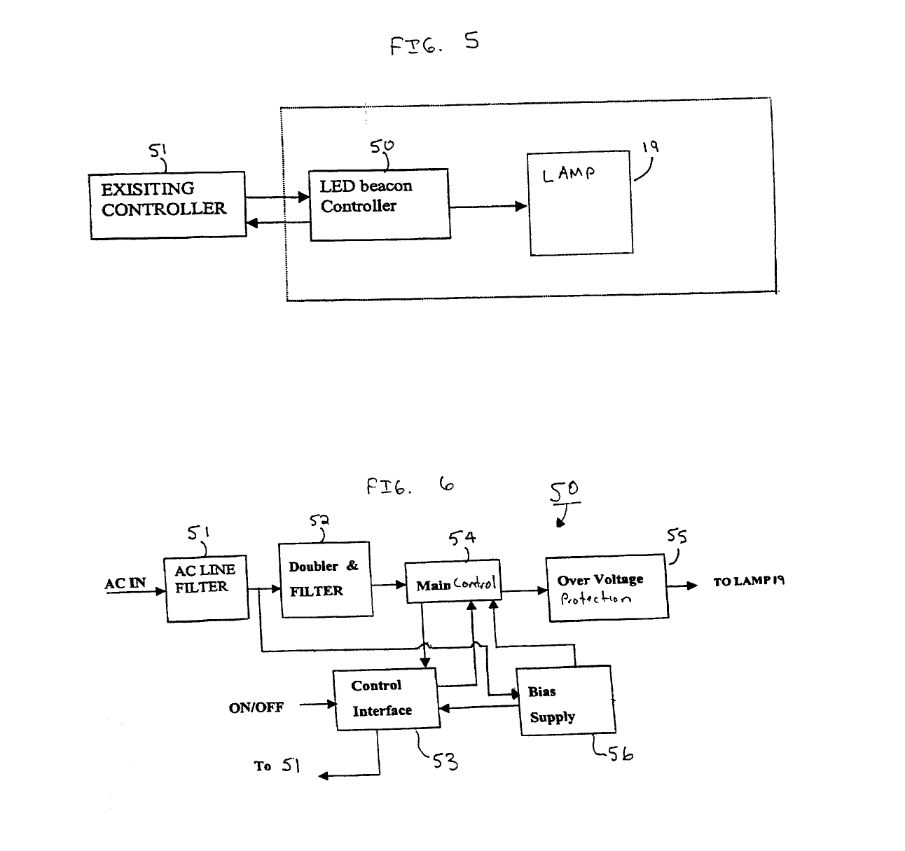

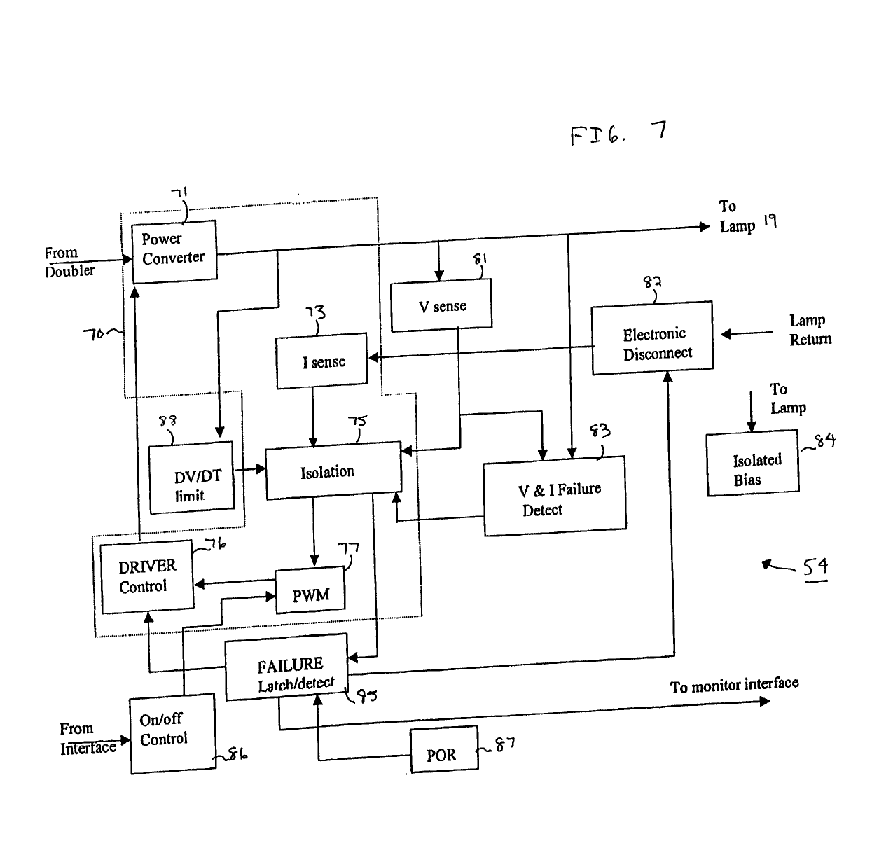

As discussed above, and as shown in FIG. 5, the beacon lamp 19 can be connected to an existing controller 51 for a beacon lamp, so that the beacon lamp 19 can be easily retrofit onto existing lamp sites. As also shown in FIG. 5, the beacon lamp 19 is connected to an LED beacon controller 50. That LED beacon controller 50 may be housed in the electrical housing 21, and directly connects to the existing controller 51. FIGS. 6 and 7 detail driving and control circuitry for the beacon lamp 19 as housed in the electrical housing 21. The driving circuitry to the beacon lamp 19 can provide an adjustable electronically controlled current source.

The existing controller 51 provides to the beacon lamp 19 properly timed flashing signals and provides monitor and alarm interfaces. The LED beacon controller 50 provides a constant current source to the beacon lamp 19. By providing a constant current from the LED beacon controller 50, the LED beacon controller 50 can operate if the beacon lamp 19 is provided on a tower of any length with negligible affects. That results because the LED beacon controller 50 can adjust its output voltage to accommodate different conductor lengths, by maintaining an output of a constant current. The LED beacon controller 50 can also be adjustable in order to accommodate variations in the output of the LEDs of the beacon lamp 19.

FIG. 6 provides a more detailed disclosure of the LED beacon controller 50 of FIG. 5.

The LED beacon controller 50 has a function of providing an electrical interface between the existing controller 51 and the beacon lamp 19. The LED beacon controller 50 receives a flashing signal from the existing controller 51, processes the signal, and sends the proper amount of electrical energy to the beacon lamp 19. The LED beacon controller 50 also provides a monitoring function which can signal to the existing controller 51 that the beacon lamp 19 is functional.

As shown in FIG. 6 an AC line filter 51 receives an input AC voltage. The AC line filter filters the high frequency components of the input current, and provides a filtered output of the input AC voltage to a doubler and filter 52, i.e. a rectifier filter, and to a bias supply 56. The bias supply 56 provides the unit with the required voltages to operate the power control circuits and the interfaces to the existing controller 51.

The doubler and filter 42 multiplies the input voltage to twice the peak on the AC input. The doubler and filter circuit 52 can also increase the input voltage above a maximum voltage required by the beacon lamp 19 based on and the height of the tower, and can filter out the low frequency AC line ripple. The filtered AC line voltage provided to the doubler and filter 52 is multiplied by two, to provide a voltage to the main control 54. As one typical operating embodiment, the AC input to the doubler and filter 52 can be multiplied by two to provide a voltage input to the main control 54 of 300 Vdc filtered. The main control 54 processes the input voltage, i.e. the 300 Vdc, by PWM techniques to supply the beacon lamp 19 with an adjustable current source.

The main control 54 provides its output voltage to the over voltage protection circuit 55 and the control interface 53. The over voltage protection circuit 55 monitors the voltage output of the main control 54 and can short out the output to protect the beacon lamp 19 when an over voltage is output. That is, the over voltage protection circuit 55 can, when activated, generate a short circuit across the beacon lamp 19 and cause a series fuse to open, to protect the beacon lamp 19 from an over voltage. The control interface 53 receives signals from the existing controller 51, processes the signal, and sends an on/off signal to the main control 54. The control interface 53 can also receive a status of the lamp from the main control 54 and can provide the status to the existing controller 51 via, e.g., a 10 amp ac signal for incandescent monitor circuits or other formats in the existing controller 51.

The main control 54 thus provides several functions of power control, alarm control, lamp protection, on/off control, and other miscellaneous functions. The main control 54 thus controls the current supply to the beacon lamp 19 on the tower to thereby control the intensity of light output by the beacon lamp 19.

Further details of the main control 54 of FIG. 6 are provided in FIG. 7.

First, FIG. 7 includes a block power converter 70, shown in the dotted lines, which itself is made up of a power converter 71, an I sense circuit 73, an isolation circuit 75, a driver control circuit 76, and a PWM circuit 77.

The current flows from the main control 54 through the beacon lamp 19 and back into the main control 54 via the lamp return input. The lamp current is regulated by the power converter circuit 71. Such a function may be achieved by utilizing a standard buck converter topology with feedback.

The lamp current is sensed by the I sense circuit 73 and is compared against a reference current to produce an error signal through the isolation circuit 75 provided to the PWM circuit 77. That error signal is representative of the difference between the sensed lamp current and the reference lamp current. The PWM circuit 77 converts the error voltage to a pulse width modulated signal, proportional to the error voltage. The pulse width modulation signal is then fed to the driver control 76, which controls the current provided to the beacon lamp 19.

The LED beacon controller 50 also provides circuitry to protect from over voltage and over current situations. A voltage failure mode can occur when resistance in the beacon lamp 19 increases. To achieve such operations, the V sense circuit 81 senses an output voltage from the power converter 71, i.e. a voltage being provided to the beacon lamp 19, and when the sensed voltage reaches a predetermined set point, i.e., a first threshold valve, the V sense circuit 81 can override the current control signal using, e.g., a wired “ORed” circuit in the isolation block 75. The V sense circuit 81 can then control the output to the beacon lamp 19 to provide a constant voltage to the beacon lamp 19. At the time of such an over voltage situation, the other circuits operate as in a normal current mode of operation and the V&I failure detection circuit 83 can detect that condition of the over voltage and indicate a failure, such as by an LED indicator. However, such a condition will not shut down the beacon lamp 19 and the beacon lamp 19 can remain lit, although it may have a decreased brightness. If the voltage or current does exceed an absolute maximum value, i.e. a second threshold value, the V&I failure detection circuit 83 can detect either condition as a major failure and can activate an electronic disconnect circuit 82 which can latch off all controls to provide an open circuit in the beacon lamp 19, and to thereby shut down the beacon lamp 19, through operation in the failure latch/detect circuit 85.

The main control 54 also includes an on/off control circuit 86 which can activate the beacon lamp 19 with a proper signal.

The main control 54 also includes a DV/DT limit circuit 88, a power on reset (POR) circuit 87, and an isolated bias circuit 84. The DV/DT limit circuit 88 is active during a leading edge of the beacon lamp's 19 on time, and can limit a rate of a voltage rise across an output capacitor of the beacon lamp 19. Such a limiting operation can limit a voltage overshoot and surge current in the output capacitor. The power on reset (POR) circuit 87 resets the fault latches and ensures an orderly start up when power is applied. The isolated bias circuit 84 can provide power for all the circuits which are not at the same reference as output by the bias supply circuit 56.

The beacon lamp 19 will also typically operate in a flashing mode. To maximize reliability of the system, flashing can be accomplished by switching output transistors on and off rather than continual toggling of an entire power supply.

Obviously, numerous modifications and variations of the present invention are possible in light of the above teachings. It is therefore to be understood that within the scope of the appended claims, the present invention may be practiced otherwise than as specifically described herein.

1. A beacon lamp comprising:
a) abase;
b) at least one module secured to said base;
c) at least one light emitting diode (LED) mounted on said at least one module;
d) a drive circuit configured to drive said at least one LED; and
e) a transparent outer cover configured to cover said at least one LED.

2. A beacon lamp according to claim 1, wherein said at least one module (b) comprises (b1) a plurality of heat sinking fins.

3. A beacon lamp according to claim 2, wherein said outer cover (d) comprises (d1) a first screen portion.

4. A beacon lamp according to claim 1, wherein said at least one LED (c) comprises a plurality of parallel connected LEDs.

5. A beacon lamp according to claim 1, wherein said drive circuit (d) comprises a regulated dc constant current source.

6. A beacon lamp according to claim 1, wherein said drive circuit (d) comprises an over voltage protection circuit to provide a short circuit if an overvoltage is detected.

7. A beacon lamp according to claim 1, wherein said drive circuit (d) comprises a pulse width modulator to control a current signal provided to said at least one LED.

8. A beacon lamp according to claim 1, wherein said base (a) comprises (a1) a first screen portion.

9. A beacon lamp according to claim 3, wherein said base (a) comprises (a1) a second screen portion.

10. A beacon lamp according to claim 1, further comprising (f) a clamp latch configured to clamp said outer cover in position to said base.

11. A beacon lamp according to claim 1, wherein said at least one module (b) comprises (b1) first and second modules on which said at least one LED is mounted.

12. A beacon lamp according to claim 1, further comprising (f) a module knob configured to secure said at least one module to said base.

13. A beacon lamp according to claim 11, further comprising (f) first and second module knobs configured to secure said first and second modules to said base.

14. A beacon lamp according to claim 1, further comprising (f) a telescoping tube configured to connect said outer cover to said base.

15. A beacon lamp according to claim 14, further comprising (g) a clamp latch configured to clamp said outer cover in position to said base.

16. A beacon lamp according to claim 14, wherein said at least one module (b) comprises (b1) first and second modules on which said at least one LED is mounted.

17. A beacon lamp according to claim 15, further comprising (g) a module knob configured to secure said at least one module to said base.

18. A beacon lamp according to claim 16, further comprising (g) first and second module knobs configured to secure said first and second modules to said base.

19. A beacon lamp according to claim 1, wherein said at least one module (b) comprises (b1) at least one Fresnel lens aligned with said at least one LED to converge light output by said at least one LED.

20. A beacon lamp comprising:
a) base means;
b) at least one support means secured to said base means;
c) at least one light emitting means mounted on said at least one support means;
d) drive means for driving said at least one light emitting means;
e) cover means for covering said at least one light emitting means.

21. A beacon lamp according to claim 20, further comprising (f) clamp means for clamping said cover means in position to said base means.

22. A beacon lamp according to claim 20, wherein said at least one support means (b) comprises (b1) first and second support means on which said at least one light emitting means is mounted.

23. A beacon lamp according to claim 20, further comprising (f) securing means for securing said at least one support means to said base means.

24. A beacon lamp according to claim 22, further comprising (f) first and second securing means for securing said first and second support means to said base means.

25. A beacon lamp according to claim 20, further comprising (f) telescoping means for connecting said cover means to said base means.

26. A beacon lamp according to claim 25, further comprising (f) clamp means for clamping said cover means in position to said base means.

27. A beacon lamp according to claim 22, wherein said at least one support means (b) comprises (b1) first and second support means on which said at least one light emitting means is mounted.

28. A beacon lamp according to claim 23, further comprising (f) securing means for securing said at least one support means to said base means.

29. A beacon lamp according to claim 24, further comprising (f) first and second securing means for securing said first and second support means to said base means.
